(19) United States
(12) Patent Application Publication
(10) Pub. No.: US 2010/0300672 A1
(43) Pub. Date: Dec. 2, 2010

(54) Time and efficiency manifold

(76) Inventors: Everett L. Childress, Tuttla, OK (US); Michael R. Smego, Oklahoma City, OK (US); Anthony L. McSparrin, Mustang, OK (US)

Correspondence Address: Henry C. Query, Jr., 504 S. Pierce Avenue, Wheaton, IL, 60187, US

(21) Appl. No.: 12/454,961

(22) Filed: May 27, 2009

(51) Int. Cl. F16L 41/00; E21B 34/00; E21B 41/00

(52) U.S. Cl. 166/52; 137/561 A

(57) ABSTRACT

A manifold for connecting one or more well service or completion apparatuses to a plurality of hydrocarbon wells comprises a block member which includes a flow bore having an inlet branch and a number of outlet branches, an inlet cross which is connected to the block member over the inlet branch, the inlet cross comprising an outlet bore which is in fluid communication with the inlet branch and a number of inlet bores which are in fluid communication with the outlet bore, a number of valves, each of which is connected to the bock member in fluid communication with a corresponding outlet branch, and a number of outlet crosses, each of which is connected to a corresponding valve. Each outlet cross comprises an inlet passage which is in fluid communication with the valve and plurality of outlet passages which are in fluid communication with the inlet passage. Accordingly, one or more fluids may be communicated simultaneously into the flow passage through the inlet bores in the inlet cross, and the fluids may be selectively communicated simultaneously through all of the outlet passages of a corresponding outlet cross by operation of its corresponding valve.

### BACKGROUND OF THE INVENTION

The present invention relates to a manifold for connecting one or more well service or completion apparatuses, such as well service pumping units, to a plurality of hydrocarbon wells.

High pressure well service pumping units are commonly used in the hydrocarbon production industry to inject a variety of fluids into an oil or gas well during certain well completion and servicing operations. For example, during a fracturing operation such pumping units are used to inject a particle-containing slurry into the well in order to fracture the hydrocarbon bearing formation and thereby produce channels within the formation through which the oil or gas may flow.

Typical fracturing operations require the use of several pumping units operating in unison to inject a large volume of slurry into the well. The pumping units are connected, either directly or through a high pressure frac vessel, to a manifold having several outlets. The outlets in turn are connected to respective inlets on a frac tree mounted to the top of the well. Usually, the manifold employs a separate valve to control the flow through each outlet. However, this arrangement makes the manifold large and ungainly.

### SUMMARY OF THE INVENTION

In accordance with the present invention, a manifold is provided which comprises a block member which includes a flow bore having an inlet branch and a number of outlet branches; an inlet cross which is connected to the block member over the inlet branch; the inlet cross comprising an outlet bore which is in fluid communication with the inlet branch and a number of inlet bores which are in fluid communication with the outlet bore; a number of valves, each of which is connected to the bock member in fluid communication with a corresponding outlet branch; and a number of outlet crosses, each of which is connected to a corresponding valve. Each outlet cross comprises an inlet passage which is in fluid communication with the valve and plurality of outlet passages which are in fluid communication with the inlet passage. In this manner, one or more fluids may be communicated simultaneously into the flow passage through the inlet bores in the inlet cross, and the fluids may be selectively communicated simultaneously through all of the outlet passages of a corresponding outlet cross by operation of its corresponding valve.

These and other objects and advantages of the present invention will be made apparent from the following detailed description, with reference to the accompanying drawings. In the drawings, the same reference numbers are used to denote similar components in the various embodiments.

### BRIEF DESCRIPTION OF THE DRAWINGS

FIG. 1 is a top view of one embodiment of the TE manifold of the present invention shown connected between a number of exemplary pumping units and a number of representative wellheads;

FIG. 1A is an enlarged view of the portion of FIG. 1 designated 1A;

FIG. 1B is an enlarged view of the portion of FIG. 1 designated 1B;

FIG. 2 is a top view of a second embodiment of the TE manifold of the present invention;

FIG. 3 is a top view of two TE manifolds of FIG. 2 shown connected together in a side-by-side relationship; and

FIG. 4 is a front elevation view of another embodiment of the TE manifold of the present invention.

### DETAILED DESCRIPTION OF THE INVENTION

The present invention provides a manifold for connecting one or more well service or completion apparatuses to a plurality of hydrocarbon wells. The well service or completion apparatuses may be, e.g., well service pumping units which are used for well stimulation operations, such as well fracturing operations. In this case, a frac tree is installed on each well to provide a means for injecting the stimulation fluid from the manifold into the well. Although the manifold of the present invention may be used with a variety of well service and completion apparatuses, for purposes of simplicity the invention will be described in connection with well service pumping units which are employed in a well fracturing operation.

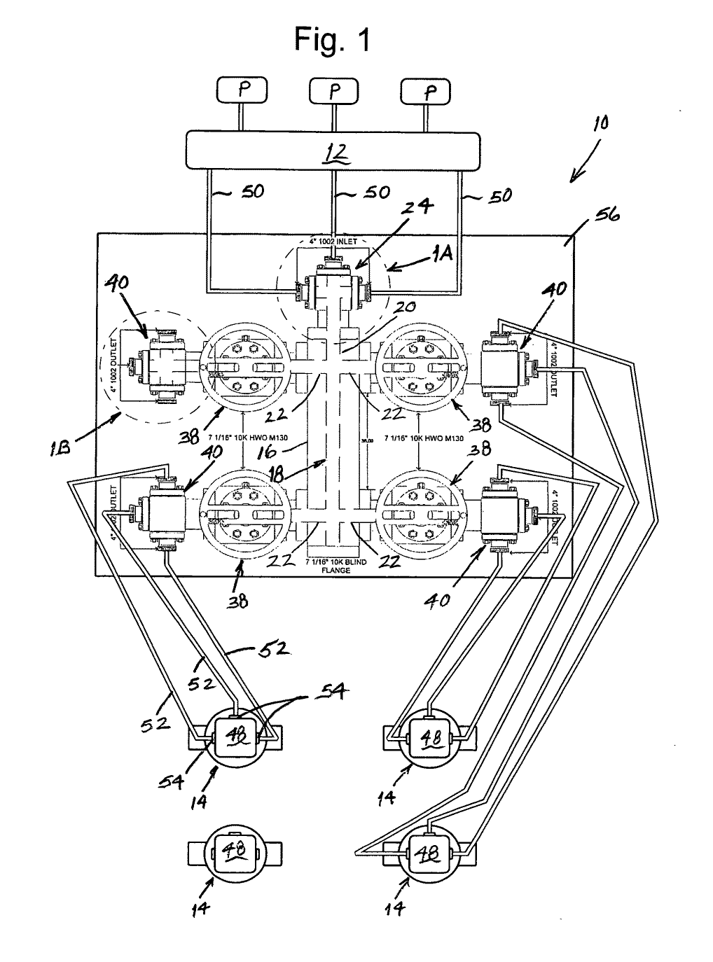

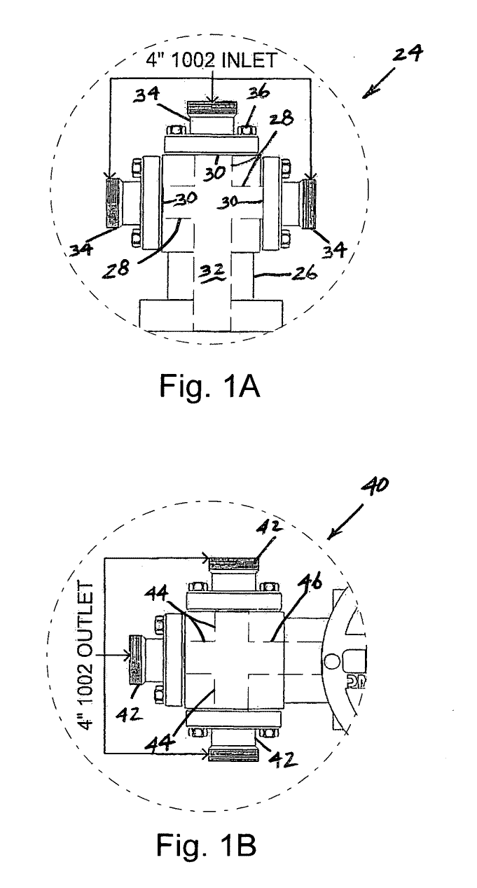

Referring to FIG. 1, a time and efficiency (“TE”) manifold in accordance with a first embodiment of the present invention, generally 10, is shown connected between a high pressure frac vessel 12 and a number of representative wellheads 14. The high pressure frac vessel 12 is fed by a number of high pressure pumping units P. In certain applications, however, the high pressure frac vessel 12 may be eliminated and the pumping units P may be connected directly to the TE manifold 10.

The TE manifold 10 includes a block member 16. The block 16 is ideally a solid piece of metal through which a flow bore 18 is machined. The flow bore 18 includes an inlet branch 20 and a number of outlet branches 22.

At least one inlet cross 24 is connected to the block 16 by suitable means, such as bolts (not shown). Referring also to FIG. 1A, the inlet cross 24 comprises a body 26 and a number of inlet bores 28, each of which extends through the body between a corresponding inlet port 30 and a common outlet bore 32. The inlet cross 24 is connected to the body such that the outlet bore 32 is in fluid communication with the inlet branch 20.

The inlet cross 24 also includes a number of inlet connection adapters 34, each of which is connected to the body 26 over a corresponding inlet port 30 by, e.g., bolts 36. The inlet connection adapters 34 may comprise any suitable connector to which a corresponding connector may be secured, such as an adapter union.

The TE manifold 10 also includes a number of valves 38, each of which is, e.g., bolted to the block 16 over a corresponding end of an outlet branch 22. Thus, each valve 38 serves to control the flow of fluid from a corresponding outlet branch 22. Although the valves 38 may comprise any suitable flow control device, in the illustrated embodiment of the invention they are manually operated gate valves.

In accordance with the present invention, the TE manifold 10 further includes a number of outlet crosses 40, each of which is connected to a corresponding valve 38. The outlet crosses are ideally of identical construction to the inlet cross 24 discussed above. Referring also to FIG. 1B, each outlet cross 40 comprises a number of outlet connection adapters 42, similar to the inlet connection adapters 34, which are each connected to a corresponding outlet passage 44. The outlet passages 44 are each connected to a common inlet passage 46. The inlet passage 46 is in turn connected via the valve 38 to a corresponding outlet branch 22 in the block 16. Thus, each valve 38 serves to control the flow of fluid from the flow bore 18 to all of the outlet passages 44 in a corresponding outlet cross 40.

In use, the high pressure frac vessel 12 is connected to the inlet cross 24 and each outlet cross 40 is connected to a corresponding frac tree 48 which has been installed on a respective wellhead 14. In particular, a number of high pressure lines 50 are used to connect the high pressure frac vessel 12 to corresponding inlet connection adapters 34 on the inlet cross 24. Also, each outlet connection adapter 42 on a particular outlet cross 40 is connected to a high pressure line 52 which in turn is connected to a corresponding inlet connection 54 on the frac tree 48. Thus, while the inlet cross 24 is connected to multiple pumps lines 50, each frac tree 48 is connected to a single outlet cross 40. However, since each outlet cross 40 comprises multiple outlet passages 44, a single frac tree 48 may be connected to several high pressure lines 52. Moreover, since flow from the flow bore 18 into each outlet cross 40 is controlled by a corresponding valve 38, each of these high pressure lines 52 can be controlled with a single valve.

The block member 16 and the valves 38 are preferably supported on a single skid 56. In one embodiment of the invention, the block 16 and/or one or more of the valves 38 is connected to the skid by suitable means, such as mounting brackets (not shown). This arrangement allows the TE manifold 10 to be transported and positioned on site as a unified assembly.

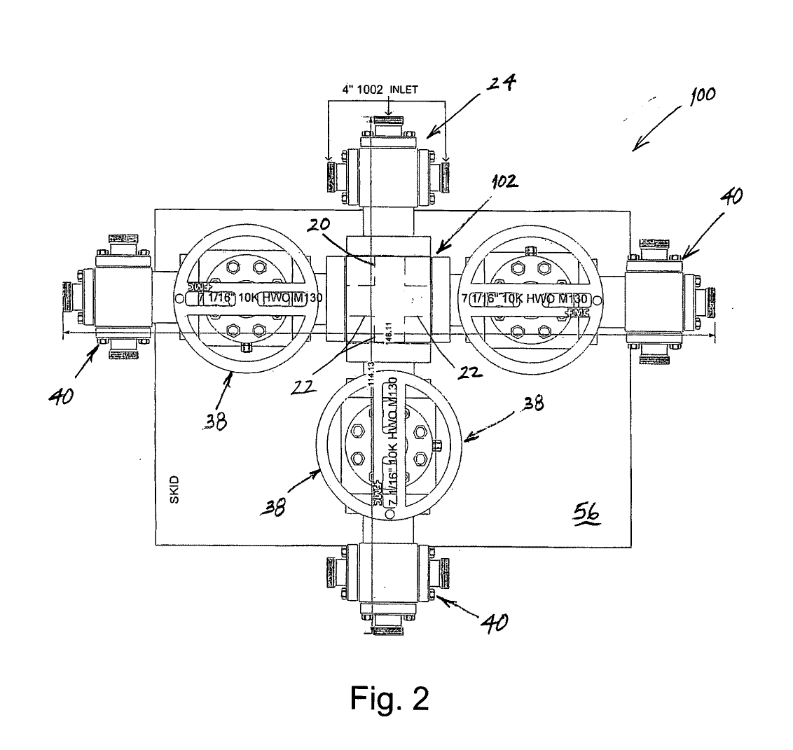

Another embodiment of the present invention is shown in FIG. 2. The TE manifold of this embodiment, generally 100, is somewhat similar to the TE manifold 10 described above. However, instead of the block 16, the TE manifold 100 comprises a simple four-way cross block 102. As in the previous embodiment, the cross block 102 includes a flow bore 18 which includes an inlet branch 20 and a number of outlet branches 22. In addition, an inlet cross 24 is connected to the cross block 102 over the inlet branch 20, and a respective valve 38 is connected to the cross block over each outlet branch 22. Furthermore, a respective outlet cross 40 is connected to each valve 38. Thus, as in the previous embodiment, a single valve 38 is capable of controlling the entire pumping and isolation functions for one well 14. The TE manifold 100 also ideally includes a skid 56 on which the cross block 102 and the valves 38 are supported.

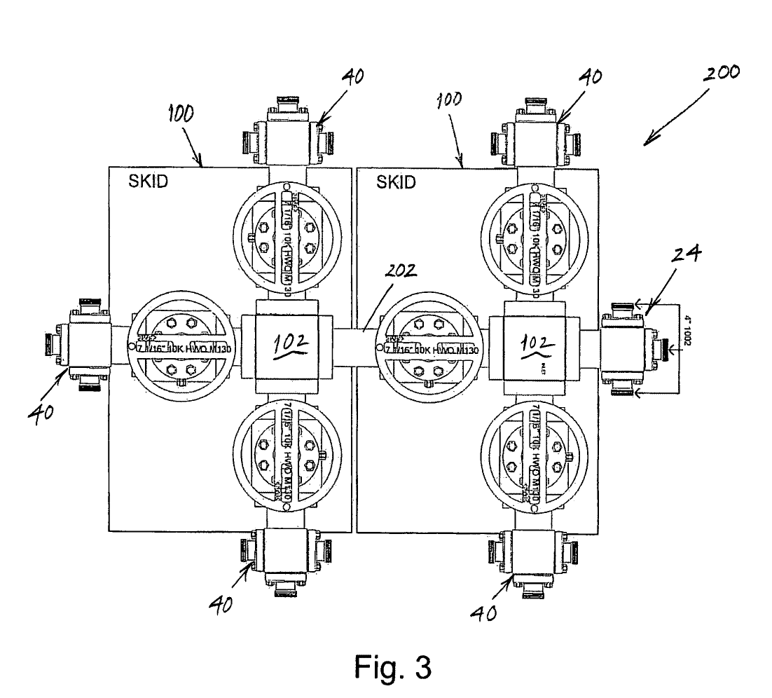

The compact design of the TE manifold 100 facilitates its use in a modular manifold system. Referring to FIG. 3, for example, two TE manifolds 100 are shown connected together in a TE manifold system, generally 200. In this embodiment, one of the outlet crosses 40 on the right-hand TE manifold 100 has been removed from a selected valve, the inlet cross 24 on the left-hand TE manifold has been removed, and the selected valve 38 on the right-hand TE manifold is connected to the cross block 102 of the left-hand TE manifold via a spool 202. As an alternative, the selected valve 38 may also be removed and the cross block 102 of the right-hand TE manifold 102 may be connected directly to the cross block of the left-hand TE manifold with a longer spool 202.

In addition to connecting the TE manifolds 100 together with the spool 202, the TE manifolds may be integrated by connecting their respective skids 56 together by suitable means. Alternatively, the TE manifolds 100 may be mounted on a single skid.

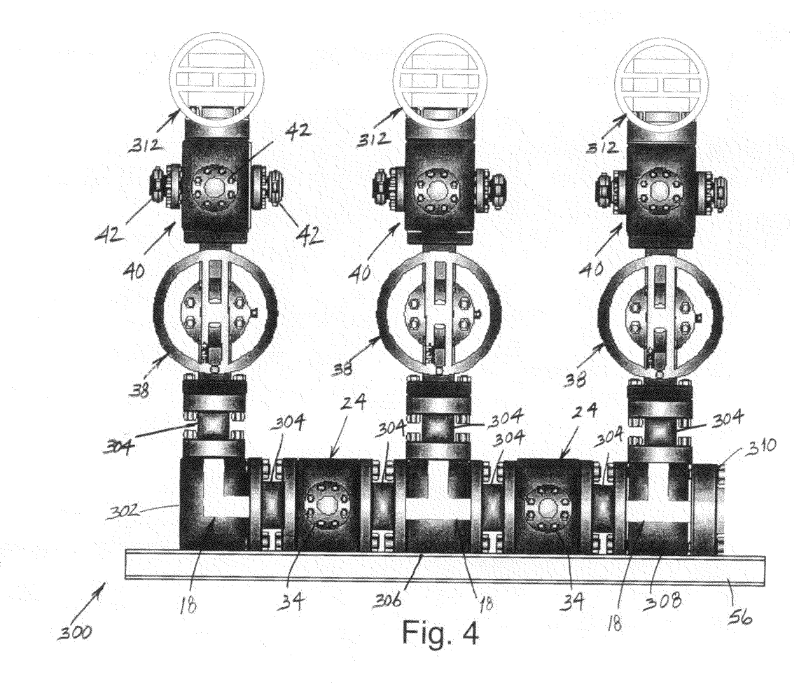

A further embodiment of the present invention is shown in FIG. 4. The TE manifold of this embodiment, generally 300, is shown to comprise, e.g., two inlet crosses 24, each of which includes a number of inlet bores which are each connected to a corresponding inlet adapter 34 and a number of outlet bores which are each connected to all of the inlet bores.

In this embodiment, each inlet cross 24 is connected to a number of valves 38 by suitable means. For example, one outlet bore of the left-hand inlet cross 24 is connected to an L-block member 302 via a first spool 304. The L-block 302 in turn is connected to the left-hand valve 38 via a second spool 304. In addition, a second outlet bore of the left-hand inlet cross 24 is connected to a T-block member 306 via a third spool 304. The T-block 306 in turn is connected to the middle valve 38 via a fourth spool 304.

Similarly, the right-hand inlet cross 24 may be connected to the right-hand valve via a second T-cross 308 and a pair of spools 304. In this embodiment, the free outlet branch 22 in the right-hand T-cross 308 may be closed by a blind flange 310. In this manner, the TE manifold 300 may be expanded to include more inlet crosses, if a particular application so requires. Alternatively, the T-cross 308 may be replaced with an L-cross similar to the L-cross 302.

Referring still to FIG. 4, a respective outlet cross 40 is connected to each valve 38. Also, a plug valve 312 may be connected to the top of each outlet cross 40. The plug valves 312 allow pressure within the TE manifold 300 to be vented safely upward and away from personnel.

The design of the TE manifold 300 allows the valves 38 to be oriented vertically. In this orientation, the hand wheels face outward, rather than upward, and are therefore easily accessible. In addition, the vertical orientation of the valves 38 mitigates the possibility that proppant may intrude into the valve body cavity during stimulation operations. With horizontally oriented valves, gravity allows the proppant to settle to the bottom of the valve bore, where it may migrate behind the valve seats and into the body cavity. Orienting the valves 38 vertically, as in the TE manifold 300, eliminates this issue. Furthermore, the vertical orientation of the valves 38 allows the valves to be removed and installed relatively easily, since the connecting bolts are readily accessible and the valves can be lifted vertically.

It should be recognized that, while the present invention has been described in relation to the preferred embodiments thereof, those skilled in the art may develop a wide variation of structural and operational details without departing from the principles of the invention. Therefore, the appended claims are to be construed to cover all equivalents falling within the true scope and spirit of the invention.

What is claimed is:

1. A manifold for connecting one or more well service or completion apparatuses to a plurality of hydrocarbon wells, the manifold comprising:
a block member which includes a flow bore having an inlet branch and a number of outlet branches;
an inlet cross which is connected to the block member over the inlet branch;
the inlet cross comprising an outlet bore which is in fluid communication with the inlet branch and a number of inlet bores which are in fluid communication with the outlet bore;
a number of valves, each of which is connected to the bock member in fluid communication with a corresponding outlet branch;
a number of outlet crosses, each of which is connected to a corresponding valve;
each outlet cross comprising an inlet passage which is in fluid communication with the valve and plurality of outlet passages which are in fluid communication with the inlet passage;
wherein one or more fluids may be communicated simultaneously into the flow passage through the inlet bores in the inlet cross; and
wherein the fluids may be selectively communicated simultaneously through all of the outlet passages of a corresponding outlet cross by operation of its corresponding valve.

2. The manifold of claim 1, wherein the block member and the valves are supported on a single skid.

3. The manifold of claim 1, wherein the block member comprises a single inlet branch and three outlet branches.

4. The manifold of claim 1, wherein each inlet cross comprises three inlet bores and a single outlet bore.

5. The manifold of claim 4, wherein each inlet bore is connectable to a separate apparatus.

6. The manifold of claim 1, wherein each outlet cross comprises a single inlet passage and three outlet passages.

7. The manifold of claim 6, wherein all outlet passages of a single outlet cross are connected to a common wellhead.

8. A manifold system for connecting one or more well service or completion apparatuses to a plurality of hydrocarbon wells, the manifold system comprising:
a first block member which includes a first flow bore having a first inlet branch and a number of first outlet branches;
a first inlet cross which is connected to the first block member over the first inlet branch;
the first inlet cross comprising a first outlet bore which is in fluid communication with the first inlet branch and a number of first inlet bores which are in fluid communication with the first outlet bore;
a number of first valves, each of which is connected to the first bock member in fluid communication with a corresponding first outlet branch;
a number of first outlet crosses, each of which is connected to a corresponding first valve;
each first outlet cross comprising a first inlet passage which is in fluid communication with the first valve and plurality of first outlet passages which are in fluid communication with the first inlet passage;
a second block member which includes a second flow bore having a second inlet branch and a number of second outlet branches;
a number of second valves, each of which is connected to the second bock member in fluid communication with a corresponding second outlet branch;
a number of second outlet crosses, each of which is connected to a corresponding second valve;
each second outlet cross comprising a second inlet passage which is in fluid communication with the second valve and plurality of second outlet passages which are in fluid communication with the second inlet passage;
wherein one of the first outlet branches is fluidly connected to the second inlet branch.

9. The manifold system of claim 8, wherein one of the first valves is fluidly connected to the second inlet branch.

10. The manifold system of claim 8, wherein the first block member and first valves are supported on a first skid and the second block member and second valves are supported on a second skid.

11. The manifold system of claim 8, wherein the first and second block members and the first and second valves are supported on a single skid.

12. A manifold for connecting one or more well service or completion apparatuses to a plurality of hydrocarbon wells, the manifold comprising:
a first inlet cross which includes a number of first inlet bores and a number of first outlet bores connected to the first inlet bores;
a first block member which is connected to the first inlet cross in fluid communication with one of the first outlet bores;
a first valve which is connected in fluid communication with the first block member;
a second block member which is connected to the first inlet cross in fluid communication with another of the first outlet bores;
a second valve which is connected in fluid communication with the second block member;
a second inlet cross which includes a number of second inlet bores and a number of second outlet bores connected to the first inlet bores;
wherein the second block is connected to the second inlet cross in fluid communication with one of the second outlet bores.

13. The manifold of claim 12, wherein the first and second block members, the first and second inlet crosses and the first and second valves are supported on a single skid.

14. The manifold of claim 12, wherein the first and second block members and the first and second inlet crosses are mounted laterally on the skid and the first and second valve members are mounted vertically over their corresponding block members.

15. The manifold of claim 12, wherein the first and second valve members are oriented vertically.
